(19) United States
(12) Patent Application Publication
(10) Pub. No.: US 2020/0089773 A1
(43) Pub. Date: Mar. 19, 2020

(54) IMPLEMENTING DYNAMIC CONFIDENCE RESCALING WITH MODULARITY IN AUTOMATIC USER INTENT DETECTION SYSTEMS

(71) Applicant: International Business Machines Corporation, Armonk, NY (US)

(72) Inventors: Yang Yu, Acton, MA (US); Ladislav Kunc, Praha 10 (CZ); Saloni Potdar, Arlington, MA (US)

(21) Appl. No.: 16/131,940

(22) Filed: Sep. 14, 2018

(51) Int. Cl. G06F 17/28; G06F 15/18; G06K 9/62; G06F 17/18; H04L 29/08

(52) U.S. Cl. CPC G06F 17/2818; G06F 15/18; H04L 67/306; G06F 17/18; G06K 9/628

(57) ABSTRACT

A method, system and computer program product are provided for implementing dynamic confidence rescaling for modularity in automatic user intent detection systems. User intents are identified using separately trained models with corresponding training data. Natural language processing (NLP) and statistical analysis are applied on the training data to classify the training data into groups and modules. A confidence rescaling algorithm is used for combining the modules. The dynamic confidence rescaling uses statistical information computed about each module being combined to identify user intents with enhanced accuracies in comparison to baseline models without confidence rescaling.

### FIELD OF THE INVENTION

The present invention relates generally to the data processing field, and more particularly, relates to a method, system and computer program product for implementing dynamic confidence rescaling for modularity in automatic user intent detection systems.

### DESCRIPTION OF THE RELATED ART

Machine learning algorithms usually work on a labeled training data and train on it to get a machine learning model. After training is finished, the model will be used to evaluate on every input test data example and output the results for each.

Business users often organize data in a modular format. For example, for a bank customer, the data could be organized into chit chat, mortgage, investment, and the like. When a bank customer wants to build a machine learning system to direct its client to detailed transaction procedure, a need exists to put all these modular data together as an integration. Therefore, a need exists for a good way to do the data integration and to design a machine learning model to have a better understanding and utilization of the modular structure. However, the common machine learning model lacks a knowledge of other examples from other modules during the training. As a result model predictions and confidences are difficult to compare across different models.

A need exists for an efficient and effective mechanism for implementing dynamic confidence rescaling for modularity in automatic user intent detection systems.

### SUMMARY OF THE INVENTION

Principal aspects of the present invention are to provide a method, system and computer program product for implementing dynamic confidence rescaling for modularity in automatic user intent detection systems. Other important aspects of the present invention are to provide such method, system and computer program product substantially without negative effects and that overcome many of the disadvantages of prior art arrangements.

In brief, a method, system and computer program product are provided for implementing dynamic confidence rescaling for modularity in automatic user intent detection systems. User intents are identified using separately trained models with corresponding training data. Natural language processing (NLP) and statistical analysis are applied on the training data to classify the training data into groups and modules. A confidence rescaling algorithm is used for combining results from the modules. The dynamic confidence rescaling uses statistical information computed about each module being combined to identify user intents with enhanced accuracies in comparison to baseline models without confidence rescaling.

In accordance with features of the invention, experimental results using real customer data and real conversational intent classification scenarios show enhanced accuracies for user intent recognition when the confidence rescaling algorithm is used.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 provides a block diagram of an example computer system for implementing dynamic confidence rescaling for modularity in automatic user intent detection systems in accordance with preferred embodiments;

FIGS. 2, 3, 4 and 5 are respective flow chart illustrating example system operations to implement dynamic confidence rescaling for modularity in automatic user intent detection systems of FIG. 1 in accordance with preferred embodiments; and

FIG. 6 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and system are provided for implementing enhanced dynamic confidence rescaling for modularity in automatic user intent detection systems. User intents are identified using separately trained models with corresponding training data. Natural language processing (NLP) and statistical analysis are applied on the training data to classify the training data into groups and modules. A confidence rescaling algorithm is used for combining results from the modules. The dynamic confidence rescaling uses statistical information computed about each module being combined to identify user intents with enhanced accuracies in comparison to baseline models without confidence rescaling.

In general, machine learning based classification usually treats each class as having equal important data. The typical machine learning based classification does not have knowledge how the classes are organized originally or which classes could be related. It is also often observed that the small classes are affected by large classes within the same training set. When data is merged into a larger training set for a higher level intent detection, the machine learning model is often easily affected and the accuracy of intents with less examples is lower as compared to training on their own data.

In accordance with features of the invention, a machine learning model adjusts a final prediction using additional structural information of the classes and maintains enhanced accuracies for most of classes including small classes. A main feature of the invention is that all training data used in the machine learning models is used to train and generate one model. Then adjusting the model prediction output uses structural information generated from multiple modules. The adaptation on model prediction output provides dynamic confidence rescaling using statistical information computed about each module being combined. Through many experiments on real customer data and real conversational intent classification scenarios, with dynamic confidence rescaling used provides improved classification accuracy overall on all modules combined to identify user intents.

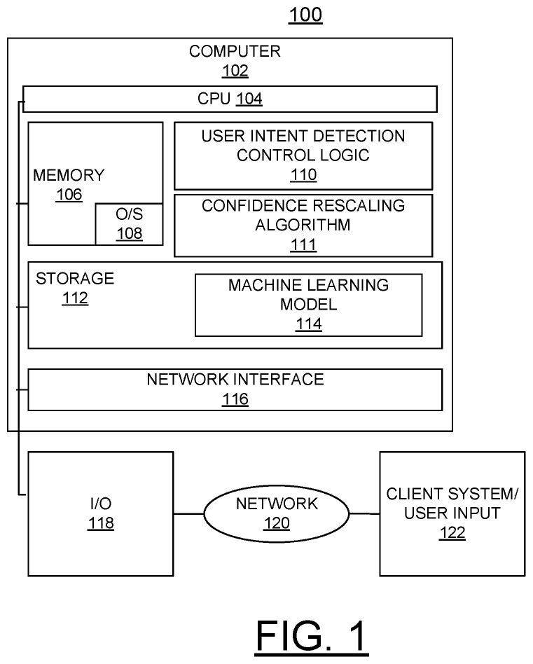

Having reference now to the drawings, in FIG. 1, there is shown an example system embodying the present invention generally designated by the reference character 100 for implementing dynamic confidence rescaling for modularity in automatic user intent detection systems in accordance with preferred embodiments. System 100 includes a computer system 102 including one or more processors 104 or general-purpose programmable central processing units (CPUs) 104. As shown, computer system 102 includes a single CPU 104; however, system 102 can include multiple processors 104 typical of a relatively large system.

Computer system 102 includes a system memory 106 including an operating system 108, a user intent detection control logic 110 and a confidence rescaling algorithm 111. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

Computer system 102 includes a storage 112 including a machine learning model 114 and a network interface 116. Computer system 102 includes an I/O interface 118 for transferring data to and from computer system components including CPU 104, memory 106 including the operating system 108, user intent detection system control logic 110, confidence rescaling algorithm 111, storage 112 including machine learning model 114, and network interface 116 and a network 120 and a client system and user input 122.

In accordance with features of the invention, dynamic confidence rescaling for modularity yields substantial gains in intent recognition accuracy over conventional intent detection systems where the intent result is composed based from multiple independent sub-domain intent detection systems.

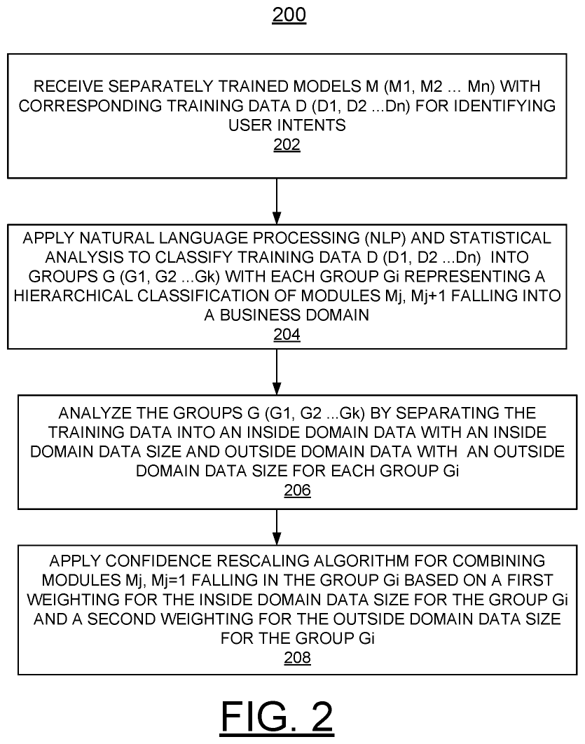

Referring to FIGS. 2, 3 and 4, there are shown respective example system operations generally designated by the reference characters 200, 300 and 400 of computer system 102 of FIG. 1, for implementing dynamic confidence rescaling for modularity in automatic user intent detection systems in accordance with preferred embodiments.

Referring to FIG. 2, system operations 200 for identifying user intents start at a block 202 with receiving separately trained models M (M1, M2, . . . , Mn) with corresponding training data D (D1, D2, . . . , Dn) for identifying user intents. As indicated at a block 204, natural language processing (NLP) and statistical analysis are applied to classify the training data D (D1, D2, . . . , Dn) into groups G (G1, G2, . . . , Gk), where each group Gi represents a hierarchical classification of modules Mj, Mj+1 falling into a business domain. As indicated at a block 206, analyzing the groups G (G1, G2, . . . , Gk) is performed by separating the training data into domain data with an inside domain data size and an outside domain data with an outside domain data size for the each group Gi. As indicated at a block 208, a confidence rescaling algorithm is applied for combining the modules Mj, Mj+1 falling in the group Gi based a first weighting for the inside domain data size for the group Gi and second weighting for the outside domain data size for the group Gi.

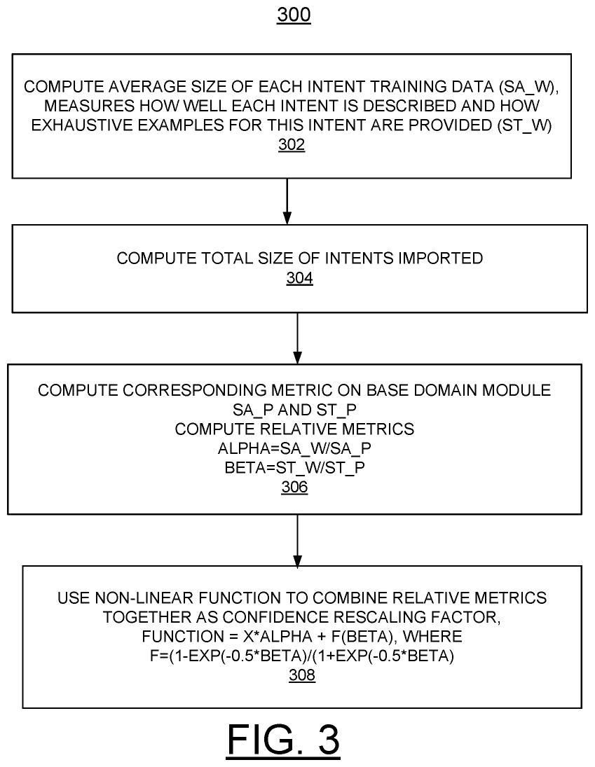

Referring to FIG. 3, system operations 300 for identifying user intents with dynamic confidence rescaling start at a block 302 first the average size of each intent training data (SA_W) is computed which counts how many training sentences each imported intent has. This metric measures generally how well each intent is described and how exhaustive the examples for this intent are provided (ST_W).

Then the total size of intents imported is computed as indicated at a block 304. The computed total size of intents imported measures how complex the imported intent domain is since the more intents imported indicates that the domain is more complex. The first two metrics (SA_W) and (ST_W) represent a relative indicator, comparing to the base domain (the module being imported to), because there is a need to compare the intent predictions between these modules. As shown in a block 306, to get the relative number for the metrics (SA_W) and (ST_W), these two metrics on base domain module are computed as well. The two corresponding metric for base domain are SA _P and ST_P. Thus, the two relative metrics are ALPHA=SA_W/SA_P and BETA=ST_W/ST_P. As shown in a block 308, a non-linear function is used to combine these metrics together as a confidence rescaling factor, the function is: X*ALPHA+F(BETA), where F is (1−EXP(−0.5*BETA))/(1+EXP(−0.5*BETA)).

The overall idea is the larger imported intent average size is the larger rescaling factor for base intent module, and the larger imported intent total size the larger rescaling factor for base intent module. In addition, to keep the base intent module stable, the re-scaling factor is a bit aggressive for a base module. This is done to prefer more important user intents over the imported ones.

Experimental results have shown that with dynamic confidence scaling, the accuracies for most intents from both modules have much better performance than simple merging without this technique. Experimental results have shown that the more intents imported, the bigger impact to original base module. Thus, stronger confidence adjusting is needed. In each importing case, experimental results have shown that different scaling factors can be obtained, ranging from 1 to 20. Experimental results have shown that dynamic confidence rescaling provides decent estimate of the rescaling factor and then provides close to optimal accuracies for most intents from both modules.

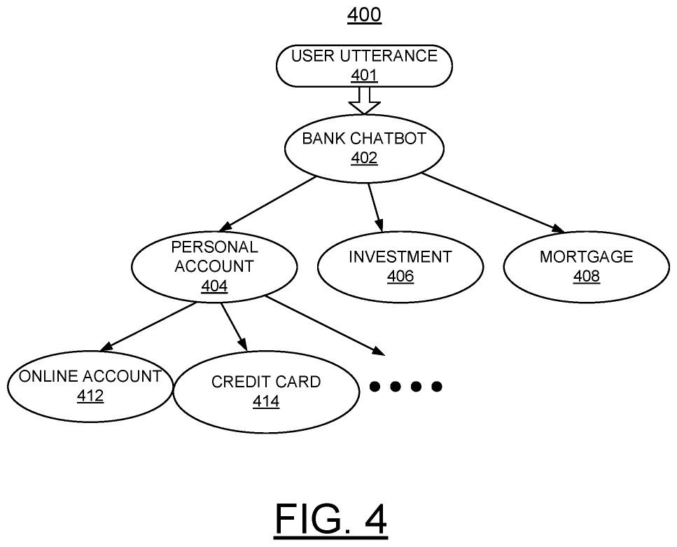

Referring now to FIG. 4, there are shown example training process system operations 400 of computer system 102 of FIG. 1, for implementing dynamic confidence rescaling for modularity in automatic user intent detection systems in accordance with preferred embodiments starting at a block 401 where user utterance is received. The example training process system operations 400 build a top classifier by merging multiple domains from bottom to top in a hierarchical order. FIG. 4 shows an example of banking bot which includes many sub-domains in levels.

As indicated at a block 402, a bank chatbot provides multiple training domains including a personal account, an investment, and a mortgage as indicated at respective blocks 404, 406, and 408. At block 404, the personal account provides further multiple training domains including an online account, a credit card, and the like, as indicated at respective blocks 404, 406, and 408.

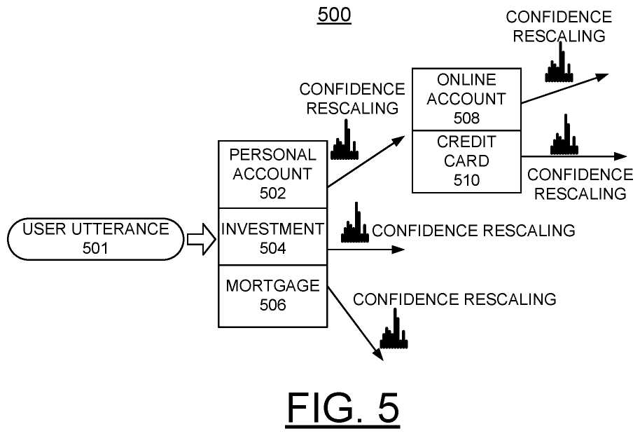

Referring now to FIG. 5, there are shown example runtime system operations 500 of computer system 102 of FIG. 1, for implementing dynamic confidence rescaling for modularity in automatic user intent detection systems in accordance with preferred embodiments starting at a block 501 where the user utterance is received. The example testing system operations 500 uses the example banking domain classifier results of merging multiple testing domains in the hierarchical order shown in FIG. 4. FIG. 5 illustrates the example domain testing classifiers used to adjust the prediction results using confidence rescaling for each classifier.

As indicated at respective blocks 502, 504, and 506, multiple domains include the personal account 502, the investment 504, and the mortgage 506. Confidence rescaling is applied to each domain of the personal account 502, the investment 504, and the mortgage 506. As indicated at respective blocks 508, and 510, multiple testing domains from personal account 502 having confidence rescaling applied include the online account 508, and the credit card 510. Confidence rescaling is applied to each domain of the online account 508, and the credit card 510.

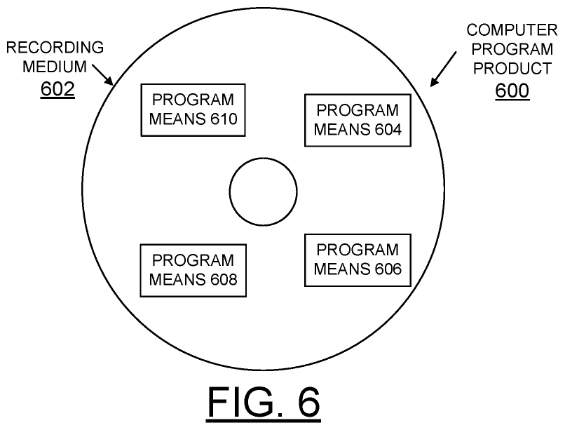

Referring now to FIG. 6, an article of manufacture or a computer program product 600 of the invention is illustrated. The computer program product 600 is tangibly embodied on a non-transitory computer readable storage medium that includes a recording medium 602, such as, a floppy disk, a high capacity read only memory in the form of an optically read compact disk or CD-ROM, a tape, or another similar computer program product. The computer readable storage medium 602, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 602 stores program means or instructions 604, 606, 608, and 610 on the non-transitory computer readable storage medium 602 for carrying out the methods for implementing dynamic confidence rescaling for modularity in automatic user intent detection systems in the system 100 of FIG. 1.

Computer readable program instructions 604, 606, 608, and 610 described herein can be downloaded to respective computing/processing devices from a computer readable storage medium or to an external computer or external storage device via a network, for example, the Internet, a local area network, a wide area network and/or a wireless network. The computer program product 600 may include cloud based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 606, 606, 608, and 610 from the network and forwards the computer readable program instructions for storage in a computer readable storage medium within the respective computing/processing device.

A sequence of program instructions or a logical assembly of one or more interrelated modules defined by the recorded program means 604, 606, 608, and 610, direct the system 100 for implementing dynamic confidence rescaling for modularity in automatic user intent detection systems of the preferred embodiment.

While the present invention has been described with reference to the details of the embodiments of the invention shown in the drawing, these details are not intended to limit the scope of the invention as claimed in the appended claims.

What is claimed is:

1. A system for implementing dynamic confidence rescaling for modularity in automatic user intent detection systems comprising:
a user intent detection control logic,
said user intent detection control logic and a confidence rescaling algorithm tangibly embodied in a non-transitory machine readable medium used to implement dynamic confidence rescaling for modularity in automatic user intent detection systems;
said user intent detection control logic, identifying user intents using separately trained models with corresponding training data;
said user intent detection system control logic, applying natural language processing (NLP) and statistical analysis on the training data to classify the training data into groups and modules; and
said user intent detection control logic, applying dynamic confidence scaling for combining the modules using statistical information computed about each module being combined to identify user intents.

2. The system as recited in claim 1, includes receiving separately trained models with corresponding training data used to implement dynamic confidence rescaling.

3. The system as recited in claim 1, wherein said user intent detection system control logic, applying natural language processing (NLP) and statistical analysis on the training data to classify the training data into groups and modules includes classifying training data into groups with each group representing a classification of modules in a domain.

4. The system as recited in claim 1, wherein said user intent detection system control logic, applying natural language processing (NLP) and statistical analysis on the training data to classify the training data into groups and modules includes applying natural language processing (NLP) based on various classes of the training data.

5. The system as recited in claim 4, includes classifying training data into groups representing a classification of successive modules in a business domain.

6. The system as recited in claim 5, includes analyzing the groups by separating training data into an inside domain data size and outside domain data size for each group.

7. The system as recited in claim 6, wherein applying dynamic confidence scaling for combining the modules includes applying a first weighting for the inside domain data size and applying a second weighting for outside domain data size for each group.

8. The system as recited in claim 1, wherein applying dynamic confidence scaling for combining the modules includes computing a total size of each imported intent in each module.

9. The system as recited in claim 1, includes computing a corresponding metric for base domain modules.

10. The system as recited in claim 9, includes computing relative metrics for the corresponding metrics for the base domain modules.

11. The system as recited in claim 10, includes applying a non-linear function to combine the computed relative metrics as a confidence scaling factor with a larger rescaling factor for base intent module with larger imported intent average size, and with a larger imported intent total size for base intent module.

12. A method for implementing dynamic confidence rescaling for modularity in automatic user intent detection systems comprising:
providing a user intent detection control logic,
providing said user intent detection control logic and providing a confidence rescaling algorithm tangibly embodied in a non-transitory machine readable medium used to implement dynamic confidence rescaling for modularity in automatic user intent detection systems including:
identifying user intents using separately trained models with corresponding training data;
applying natural language processing (NLP) and statistical analysis on the training data to classify the training data into groups and modules; and
applying dynamic confidence scaling for combining the modules using statistical information computed about each module being combined to identify user intents.

13. The method as recited in claim 12, wherein applying natural language processing (NLP) and statistical analysis on the training data to classify the training data into groups and modules includes classifying training data into groups with each group representing a classification of modules in a domain.

14. The method as recited in claim 12, wherein applying natural language processing (NLP) and statistical analysis on the training data to classify the training data into groups and modules includes applying natural language processing (NLP) based on various classes of the training data.

15. The method as recited in claim 14, includes classifying training data into groups representing a classification of successive modules in a business domain.

17. The method as recited in claim 15, includes analyzing the groups by separating training data into an inside domain data size and outside domain data size for each group.

18. The method as recited in claim 17, wherein applying dynamic confidence scaling for combining the modules includes applying a first weighting for the inside domain data size and applying a second weighting for outside domain data size for each group.

19. The method as recited in claim 12, wherein applying dynamic confidence scaling for combining the modules includes computing a total size of each imported intent in each module, computing a corresponding metric for base domain modules, and computing relative metrics for the corresponding metrics for the base domain modules.

20. The method as recited in claim 19, includes applying a non-linear function to combine the computed relative metrics as a confidence scaling factor with a larger rescaling factor for base intent module with larger imported intent average size, and with a larger imported intent total size for base intent module.
